(19) United States
(12) Patent Application Publication
(10) Pub. No.: US 2016/0256247 A1
(43) Pub. Date: Sep. 8, 2016

(54) DENTAL TRANSFER TEMPLATE

(71) Applicant: IVOCLAR VIVADENT AG, Schaan (LI)

(72) Inventors: Ronny WATZKE, Feldkirch (AT); Thomas BAASKE, Mols (CH); Markus HEINZ, Naturns (IT)

(21) Appl. No.: 15/029,041

(22) PCT Filed: Oct. 16, 2014
(86) PCT No.: PCT/EP2014/072269

§ 371 Date: Apr. 13, 2016

(30) Foreign Application Priority Data
Oct. 17, 2013 (EP) 13189179.8
Sep. 11, 2014 (EP) 14184495.1

(51) Int. Cl. A61C 13/12; A61C 13/08; A61C 13/01; A61C 13/10; A61C 11/08; A61C 13/00

(52) U.S. Cl. CPC A61C 13/12; A61C 11/08; A61C 13/0004; A61C 13/01; A61C 13/1023; A61C 13/08

(57) ABSTRACT

The invention relates to a dental transfer template arrangement with a transfer template and a prosthesis base, both of which are produced using the same CAD/CAM device in particular, wherein
both have a number of recesses for teeth, incisal and/or occlusal tooth regions fitting into the transfer template recesses and cervical tooth regions fitting into the prosthesis base recesses, and
each tooth is to be adhered into a prosthesis base recess.

The invention is characterized in that
the transfer template (20) has an occlusal face (22) which corresponds to the occlusal plane and which is implemented as a reference for the presence of disruptive occlusal contacts such that
teeth regions (310) which protrude past said face (22) of the transfer template (20) can be polished for an even bite, and
the adhesive area of each tooth (31, 33, 35, 37) has a specified minimum threshold in the prosthesis base (10), in particular at least 10 mm², preferably at least 18 mm², and particularly preferably at least 25 mm², said threshold being stored in particular in the CAD software of the CAD/CAM device in order to produce the prosthesis base.

The invention relates to a dental transfer template arrangement according to the preamble of claim 1.

In the case of CAD/CAM manufactured prostheses, it is necessary to bond artificial teeth to a prosthesis base. The artificial teeth may be produced conventionally (industrially) as well as manufactured by means of CAD/CAM and are made of various materials.

Correct positioning of each tooth relative to the prosthesis base is necessary in order to permanently bond the artificial teeth in the cavity of a prosthesis base. In this way, each tooth or group of teeth is to be checked individually and manually for a proper fit and then bonded.

A so-called transfer template has already been proposed for the checking. Such a transfer template is a negative mold that is produced in particular using CAD/CAM, wherein recesses are provided to support the teeth. The teeth and/or tooth groups are stored temporarily in the recesses of the template and transferred to the cavities of the prosthesis base for bonding. Secure and correct positioning of the teeth in the cavities of the prosthesis base is ensured by means of the template before/during the bonding.

Such a transfer template can be generated by the CAD/CAM device based on scanning and CAD data, wherein both data sets are obtained respectively from a three-dimensional scan of a mouth situation of a patient, and from a template library in the CAD software. A corresponding prosthesis base is generated, in particular, by the same CAD/CAM device based on, in particular, the same scanning data and the CAD data from a prosthesis base library in the CAD software, so that, by using the transfer template, the artificial teeth can be transferred, positioned in the cavity of the prosthesis base and bonded.

Such a dental transfer template is known from WO 2012/155161 A1. According to WO 2012/155161 A1, the prosthesis teeth are placed in a defined position and held there by means of a transfer template referred to as an “ancillary support apparatus”.

Another such dental transfer template is known from EP 2 030 590 A1. Each single prosthetic tooth is held temporarily by means of wax or resin in the recess of the transfer template.

The rod 18 of the transfer template allows manual orientation and positioning of the teeth in the cavities of the prosthesis base.

However, in the case of the use of prefabricated teeth, the problem arises that interference contacts occur on the occlusal surfaces because of the non-individualized tooth lengths of the prefabricated teeth, said interference contacts being indeed represented and shown in the virtual articulator in the software, but not being included in the finalization of the prosthesis. A workable solution to this problem without transferring the finished dentures to an articulator is not yet known.

If the adhesive connection of the artificial teeth in the prosthesis base is not firm enough, the risk also arises during chewing or other movements of the teeth in the mouth, that the teeth are not held sufficiently stable in the cavity of the prosthesis base 10, and may even fall out of the prosthesis base.

Therefore, the invention has for its object the creation of a dental transfer template arrangement according to the preamble of claim 1, which avoids interference contacts on the occlusal surfaces when using prefabricated teeth and can ensure secure adhesion of dentures to the prosthesis base.

This object is inventively achieved by claim 1. Advantageous developments emerge from the dependent claims.

According to the invention, it is provided that the transfer template additionally serves as a grinding template. The transfer template has an occlusal face facing the occlusal plane. Once the prefabricated teeth are introduced and positioned in the cavity of the prosthesis base by means of the transfer template, the tooth regions protruding past the occlusal face of the transfer template lead to occlusal/incisal malocclusion. These tooth regions can be ground manually to obtain an even bite by using the transfer/grinding template.

Furthermore, secure bonding of each tooth is inventively ensured in the prosthesis base. According to the invention, the adhesive surface of each tooth in the prosthesis base has a predetermined minimum threshold, in particular at least 10 mm², preferably at least 18 mm², and particularly preferably at least 25 mm², wherein said threshold is set, in particular, in the CAD software of the CAD/CAM device in order to produce the prosthesis base. This value can also—depending on the adhesive—be increased, for example, to at least 39 mm².

In an advantageous embodiment, it is provided that the transfer template is generated in its template form with recesses for teeth by rapid prototyping or by milling. The inner surfaces of the recesses in the transfer template which correspond to the occlusal/incisal outer surfaces of the teeth, are generated based on a tooth library, said outer surfaces being stored in the CAD/CAM device corresponding in particular to prefabricated teeth.

In an advantageous embodiment, it is provided that the transfer template is manufactured from non-rigid and resilient material when compared with the teeth, in particular from plastic, so that the teeth are held in the recesses of the transfer template using a limited deformation force on the inner surfaces of the recesses of the transfer template, and can be transferred into the prosthesis base.

In an advantageous embodiment, it is provided that the transfer template is made of suitable materials, particularly metal or plastic, preferably made of transparent plastic in order to better check the positioned teeth.

In an advantageous embodiment, it is provided that in calculating the areas of the extensions in the transfer template, a manufacturing-related shrinkage factor of the prefabricated teeth of about ±100 μm is taken into account, said factor corresponding to the degree of shrinkage of the prefabricated teeth due to thermal expansion.

When using prefabricated teeth, some teeth protrude past the occlusal face of the transfer template due to the non-individualized tooth length, which leads to interference contacts in the occlusal plane. According to the invention, the regions of a tooth passing through the transfer template whose height is greater than the height extension of the transfer template and the prosthesis base in the superimposed state, can be ground manually in order to optimize the intercuspation.

In an advantageous embodiment, it is provided that the height of the teeth in the transfer template is specified based on CAD and scanning data and thus indirectly on patient data, and that the basal side of the regions of a tooth passing through the prosthesis base, whose height is greater than the height extension of the transfer template and prosthesis base and in the superimposed state of these, can be abraded to be substantially flush with the surrounding surfaces.

In an advantageous embodiment, it is provided that the transfer template has tooth recesses generated by the CAD/CAM device which thus define a spatial position of the tooth, wherein each tooth, in particular 5% to 90% of its longitudinal extension, is held by the transfer template.

In an advantageous embodiment, it is provided that the transfer template and the prosthesis base in the assembled state, leave a free space surrounding the teeth, whose height is, in particular, partly 0% to 50%, preferably about 20% of the height of the teeth.

In an advantageous embodiment, it is provided that the transfer template and the prosthesis base are supported in the superimposed state via a plurality of supporting points, in particular three, with respect to each other, and are put into a defined relative position when the teeth are inserted.

In an advantageous embodiment, it is provided that the transfer template together with the prosthesis base fixedly embeds inserted teeth in all three spatial directions, and in this state, any malocclusions of the teeth which pass through the transfer template can be abraded or milled off without additional and separate support contacts for the individual teeth.

In an advantageous embodiment, it is provided that the threshold value of the adhesive area of the teeth at the prosthesis base varies for different types of teeth—incisors, premolars and molars—and an enlargement of the adhesive area can be requested to correspondingly adjust the prosthesis base through the CAD software of the CAD/CAM device.

In an advantageous embodiment it is provided that the threshold value of the adhesive area of the teeth at the prosthesis base varies for different types of teeth, particularly for prefabricated teeth with different tooth lengths, and an enlargement of the adhesive surface can be requested to correspondingly adjust the prosthesis base (10) through the CAD software of the CAD/CAM device.

In an advantageous embodiment, it is provided that in order to enlarge the adhesive area of the teeth in the prosthesis base, the cervical region of the recesses of the prosthesis base can be extended in the incisal direction by means of the CAD/CAM device.

In an advantageous embodiment, it is provided that the CAD/CAM device on determining the height of the teeth in the recesses of the prosthesis base, takes into account an adhesive gap having a predetermined thickness according to the invention, particularly partially 0 to 500 μm, preferably 50 pm to 250 μm, so that the outer form is designed to be larger by this gap than the cervical region of the teeth, and thus the height of each tooth is precisely determined.

In an advantageous embodiment, it is provided that on the vestibular side of each tooth, window recesses are arranged so that the correct height of the teeth in the inner surfaces of the recesses in the transfer template can be checked.

In an advantageous embodiment, it is provided that the transfer template is used either for lower jaw or upper jaw prostheses due to the ground surfaces of the penetrating teeth.

In an advantageous embodiment, it is provided that the relative three-dimensional position of the upper jaw or lower jaw prosthesis is fixed so that the finished prostheses can be positioned in an articulator/occludator that is movable about the vertical axis in order to make an occlusal correction of the prosthesis teeth.

Such an articulator can simulate the movement sequences of the human jaw. The jaw hinge as such moves on lowering of the bite position or a raising thereof according to the principle of a door hinge, i.e. a rise in the front region of 3 mm corresponds to that in the mastication region of approximately ⅓ to 1 mm.

The hinge geometry differs depending on the type of articulator. To allow for this variety of hinge geometries, the vertical lowering of all articulators is carried out in the same manner. The adapter in the articulator is the same for the hinge geometry. Thus, the hinge geometry remains unaffected.

The rows of teeth of the upper and lower prosthesis are brought into contact, i.e. brought in occlusion, by means of this adapter in the articulator. In this way, the central position of the rows of teeth of the upper and lower jaw can be checked and, if necessary, readjusted through grinding. In the case of functional retouching, the dynamic adjustment and selective grinding can be performed specifically in the articulator. For this purpose, at least the hinge angle and the Benett angle are then set as a minimum requirement, depending on the articulator.

In an advantageous embodiment, it is provided that the transfer template is reusable and can be used for bonding teeth of up to two prosthesis bases.

In an advantageous embodiment, it is provided that, in particular by means of the CAD/CAM device, a distance between tooth positions for upper or lower jaw prostheses can be determined which is correlated with the vertical displacement axis of the articulator/occludator.

In an advantageous embodiment, it is provided that prefabricated teeth can be ground by breaking through the template for occlusal correction in the occlusal plane of the teeth.

Further advantages, details and features will become apparent from the following description of an exemplary embodiment through the drawings.

In the drawings:

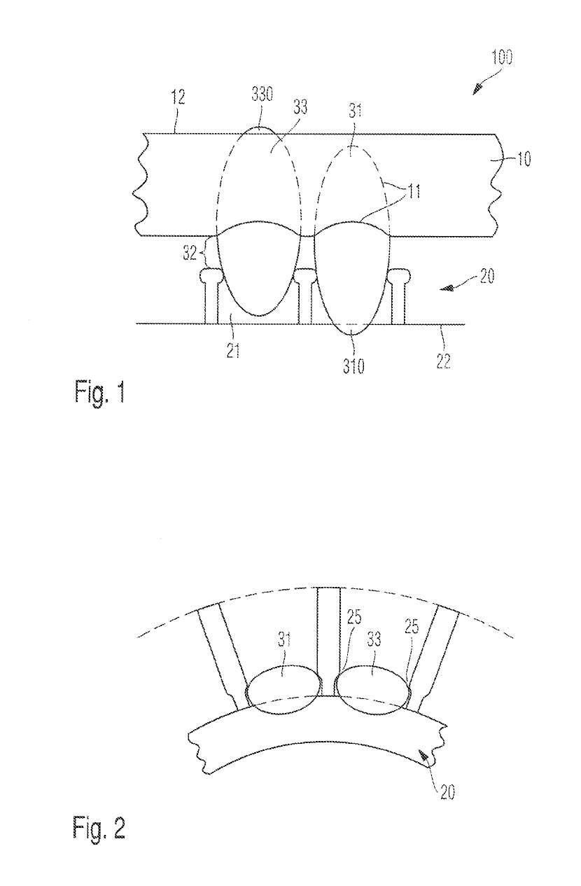

FIG. 1 shows a schematically illustrated embodiment of the dental transfer template arrangement according to the invention in a front view;

FIG. 2 shows the embodiment of the dental transfer template arrangement according to FIG. 1 in plan view (shown without the prosthesis base);

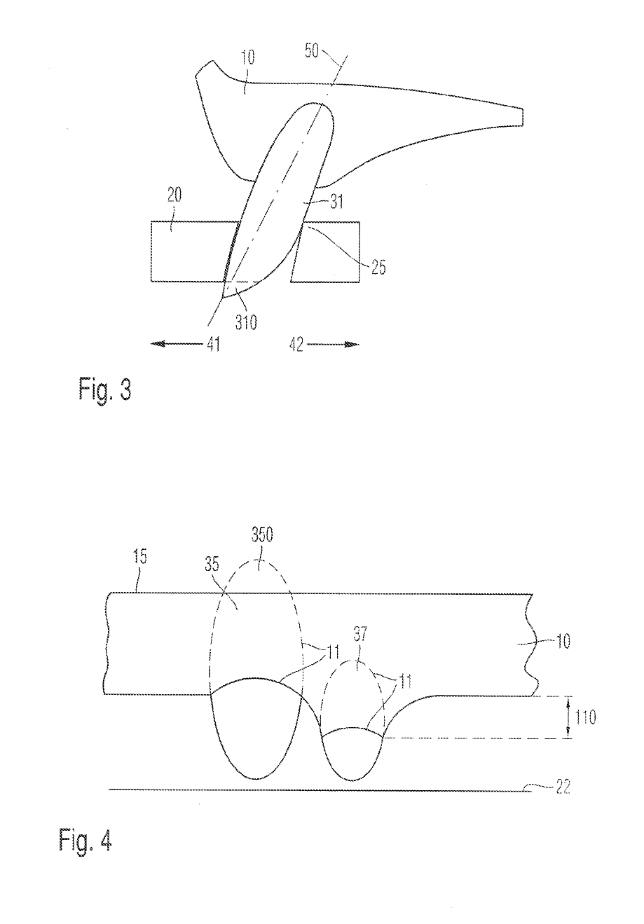

FIG. 3 shows the embodiment of the dental transfer template arrangement according to FIG. 1 in side view;

FIG. 4 shows a further embodiment of the dental transfer template arrangement (shown without the transfer template);

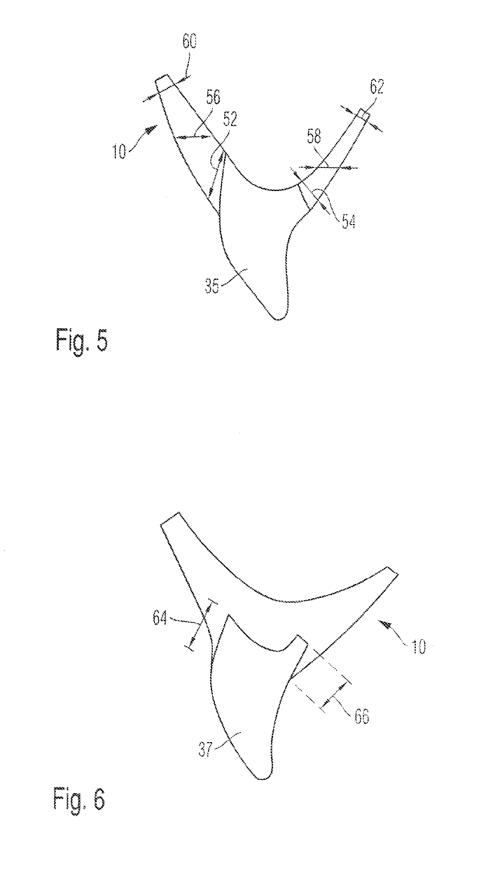

FIG. 5 shows the embodiment of FIG. 4 in side view;

FIG. 6 shows the embodiment according to FIG. 4 in side view;

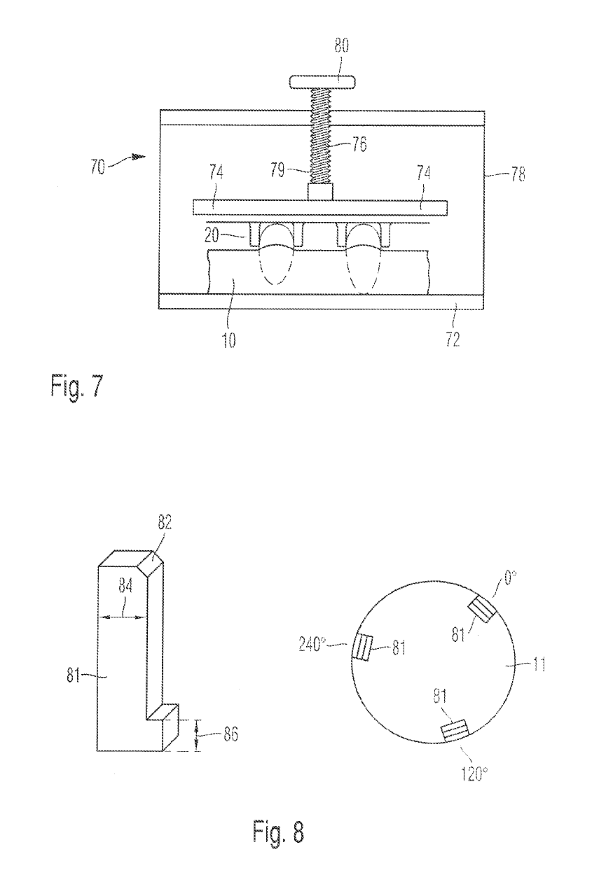

FIG. 7 shows the holding device and an embodiment of the dental transfer template arrangement;

FIG. 8 shows the spacer and its arrangement in the cavity of the prosthesis base; and

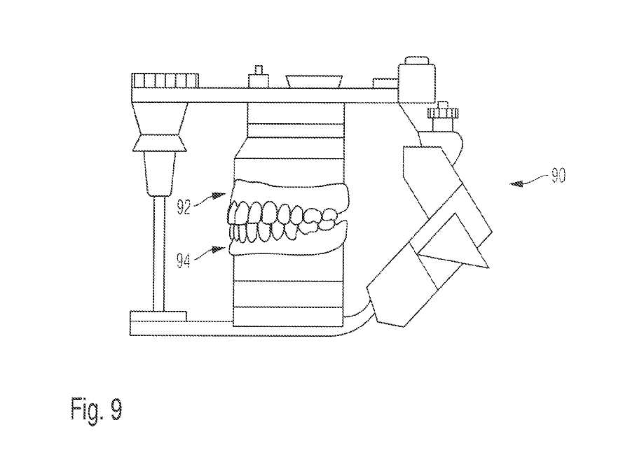

FIG. 9 shows a schematically illustrated articulator with prostheses.

The dental transfer template arrangement 100 shown in FIG. 1 comprises a transfer template 20, and a (upper jaw) prosthesis base 10, wherein both have a plurality of recesses 21 and 11 for incisors, of which the incisors 31 and 33 are shown in FIG. 1. Incisal and/or occlusal regions fit in the transfer template recesses 21 while cervical regions of the teeth 31 and 33 fit in the prosthesis base recesses 11. The incisors 31 and 33 are each to be bonded into the prosthesis base recesses 11.

The teeth 31 and 33 are inserted into the cavities/recesses 11 of the prosthesis base 10 in any suitable manner by means of the transfer template 20, whereby the teeth 31 and 33 are provisionally secured in the inner surfaces of the recesses 21 of the transfer template 20, for example, with wax, resin or other adhesive, or the teeth 31 and 33 are held by the inner surfaces of the recesses 21 in the transfer template 20 with the help of the deformation force of the transfer template. Preferably, the transfer template 20 is made of transparent plastic for better control of the positioned teeth.

Subsequently, the teeth 31 and 33 are each positioned and bonded in the prosthesis base 10 with the help of the transfer template 20.

The region 310 of the prefabricated tooth 31, which region protrudes over the occlusal face 22 of the transfer template 20, leads to interference contacts in the occlusal plane. According to the invention, the occlusal face 22 of the transfer template 20 serves as a reference height of the occlusal/incisal plane. The portion 310 protruding over the occlusal face 22 may be manually ground according to the invention in order to optimize the intercuspation.

On the vestibular side of the teeth 31 and 33, window recesses of the transfer template 20 according to the invention are arranged in order to control the correct height of the teeth 31 and 33 in the inner surfaces of the recesses 21 in the transfer template 20.

As an alternative solution to avoid interference contacts, it can be provided that for a slightly longer pre-fabricated tooth 33, the end facing the transfer template 20 does not protrude beyond the occlusal face, but that the cervical end of the tooth 33 is allowed to pass through the basal side of the prosthesis base 10.

The region 330 passing through the prosthesis base 10 is removed substantially flush, particularly by grinding or milling off.

In the embodiment of FIG. 1, the recesses 21 of the transfer template 20 fix the spatial position of the teeth 31 and 33 such that each tooth is held for about 30% by the transfer template 20. In another embodiment, this value is 5% to 90%.

The transfer template 20 shown in FIG. 1 is joined with the prosthesis base 10 in such a fashion that the transfer template 20 surrounding the teeth 31 and 33 has no physical contact with the prosthesis base 10. There is a free space 32 surrounding the teeth 31 and 33, whose height is in particular about 20% of the tooth length.

In a further embodiment (not shown), the transfer template and the prosthesis base are supported in the superimposed state via a plurality of supporting points, in particular three, with respect to each other, and are put into a defined relative position when the teeth are inserted.

In FIG. 2, a transfer template 20 according to the invention is shown in plan view with the retained teeth 31 and 33 of FIG. 1. From the combination of FIGS. 2 and 3, it can be seen that the teeth 31 and 33 each have at least three supporting points 25 on the transfer template 20, so that the teeth 31 and 33 can be secured in the recesses 21 of the transfer template 20.

In a preferred embodiment, the teeth 31 and 33 are fixedly supported in all three spatial directions with the help of the elastic deformation force of the supporting points 25 of the inner surfaces of the recesses 21 of the transfer template 20.

In FIG. 3, an inventive dental transfer template arrangement 100 according to FIG. 1 is shown in side view. The arrows 41 and 42 point in the labial and lingual directions. In the embodiment shown in FIG. 3, there is an angle between the vertical axis and the root axis 50 of about 10° to 35°.

A further embodiment of the invention is shown in FIG. 4. It can be seen that the height of the (prefabricated) tooth 35 is comparatively too large for the prosthesis base 10. If the tooth 35 is bonded in the cavity of the prosthesis base 10 without further processing, then a strong interference contact occurs in the occlusal plane. In addition, there is the danger that during the mastication movement, the tooth 35 is held unstably in the cavity of the prosthesis base 10 and may even fall out from the prosthesis base 10, in fact due to the limited adhesive area of the tooth 35 in the prosthesis base 10 with respect to the vertical plane in proportion to the area expansion of the tooth 35. Due to the leverage effect, the load arm corresponding to the adhesive force is somewhat shorter than the lever arm corresponding to the frictional force during the mastication movement.

According to the invention, it is favorable that the tooth 35 can be secured in the prosthesis base 10 with the help of the transfer template 20 (not shown) labially downwards to the occlusal plane 22 in order to prevent the interference contact, as shown in FIG. 4. Because of the greater length of the tooth 35, the tooth 35 passes through the basal surface 15 of the prosthesis base 10. In this way, the adhesive area is increased. The passing-through region 350 is then ground down according to the invention. Consequently, the load arm/lever arm ratio is improved and therefore a secure bond is ensured.

According to FIG. 4, a tooth 37 is also provided, whose height is comparatively too small for the prosthesis base 10. If the tooth 37 is bonded in a known manner in the cavity of the prosthesis base 10, the adhesive area is too small to ensure a secure bond because of the lever action upon chewing, as in the aforementioned case of the tooth 35.

According to the invention, it is particularly favorable that the CAD software for the production of the prosthesis base warns of the danger that insufficient adhesive area is available.

According to the invention it is further favorable that the cavity 11 of the prosthesis base 10 is so transformed under the control of the CAD/CAM device that the cervical region of the cavity 11 extends in the incisal direction. The extent of extension is designated in FIG. 4 as the height 110. The elongated cavity 11 of the prosthesis base 10 shown in FIG. 4 according to the invention, allows additional adhesive area of the tooth 37 in the prosthesis base 10. A secure adhesive bond is ensured in this way.

The teeth 35 and 37 are shown in side view in FIG. 5 and FIG. 6.

The thickness of the collar region of the prosthesis base 10 at the cervical margin of the teeth 35 and 37 labial 56 (or buccal) and palatal 58 (or lingual) must be more than 2 mm.

The thickness at the minimally highest point (2 mm of the collar regions 60 and 62 must be more than 0.5 mm. Thereafter, the thickness may level off.

According to the invention, it is favorable that the benchmark figures concerning the minimum requirements of the bonding are adjustable in the CAD software, wherein two scenarios are exemplified:

Case 1—Bonding without or partially with basal contact to the prosthesis base 10 corresponding to the tooth 35 according to FIG. 5: minimum height of the collar region 52 and 54 of the prosthesis base 10 must be more than 2 mm, over 360° all around;

Case 2—Bonding with full basal contact to the prosthesis base 10 corresponding to the tooth 37 according to FIG. 6:

minimum height of the collar region 64 and 66 of the prosthesis base 10 must be more than 2 mm, over 180° all around, preferably labial and palatal (or buccal and lingual) inclusive, and the minimum height of the collar region of the prosthesis base 10 must be more than 1 mm for the remaining 180°.

In case 1, the optimum collar height should be more than 3 mm, wherein a bulge or a coating is provided, which presents a prolongation of the cavity 11 of the prosthesis base 10 in FIG. 4, wherein at least 50% of the coating is located preferably in the lingual or palatal area.

According to the invention, it is further favorable, based on the above benchmark figures, that the minimum adhesive surface, which ensures a secure bonding of the tooth to the prosthesis base, can be calculated and particularly fixed in the CAD software for the production of the prosthesis base 10.

If the currently smallest tooth form A3 of the applicant without basal depression is used, the scope of the tooth A3 measured at the collar middle height is 14.6 mm, while the bottom area of the tooth A3 is 16.97 mm² (the following algorithm is also applicable for alternative tooth shapes having other sizes or from other companies).

In the above-mentioned case 1, i.e. bonding without or partially with basal contact with the prosthesis base, there results a minimal adhesive area of 14.6 mm×2 mm=29.2 mm².

In the above-mentioned case 2, i.e. bonding with full basal contact with the prosthesis base, the entire adhesive area from the combination of the collar region and the basal region is calculated, whereby the minimal adhesive area results as:
Collar region over 180° with 2 mm height=14.6 mm/2×2 mm=14.6 mm²;
Collar region over 180° with 1 mm height=14.6 mm/2×1 mm=73 mm²;
Basal region with full basal contact with the prosthesis base=16.97 mm²;
Minimum adhesive area=14.6 mm² 7.3 mm² 16.97 mm²=38.87 mm².

According to the Moffit composite test (lever test), a breaking load of 500N is obtained for the teeth in the case of the aforementioned minimum adhesive areas. Here, it is convenient to roughen the surfaces immediately before bonding, preferably by sandblasting with aluminum oxide particles with a particle size of 100 μm and a pressure of 1 to 2 bar. Further, it may be advantageous to pre-wet the adhesive areas, for example, with ProBase cold Monomer of the present applicant, in particular when composite teeth are used, whereby the cutting layer extends into the cervical region.

FIG. 7 shows a holding device 70 for the lower jaw and/or upper jaw prosthesis, whereby the said device can support/ensure the fixing of the teeth to the prosthesis base 10 or the curing of the adhesive.

The holding device 70 comprises a substrate 72, a frame 78, at least three bars 74 (only two of them shown in FIG. 7), a die 79 with a thread 76 and a turning handle 80.

The prosthesis base 10 together with the teeth in the cavities of the latter and the transfer template 20 can be applied and fixed to the substrate 72 of the holding device 70.

By turning the handle 80, the bars 74 are raised and lowered in the vertical direction above the die 79. When, according to FIG. 7, the bars 74 are lowered down onto the top of the transfer template 20 and then lowered still further, a pressure of the bar 74 is applied downwards via the transfer template 20 on the teeth and the prosthesis base 10.

The prosthesis base 10 is then clamped by the teeth and the substrate 72 of the holding device 70 thus fixing the teeth in the prosthesis base 10 and supporting curing of the adhesive. A central arrangement of the die 79 results in a uniform holding force.

According to the invention, it is further favorable that the adhesive gap between the teeth and the prosthesis base that is defined in the CAD software is 100 μm. In order to accurately center the teeth in the cavities of the prosthesis base 10 during the positioning and bonding, and if it is desired to ensure an adhesive gap of 100 μm around the teeth, then, according to the invention, it is favorable to use at least three spacers 81 as shown in FIG. 8. Without spacers, the adhesive gap is 78 to 160 μm, but with spacers, the width fluctuation cannot be measured.

The tooth recess 11 of the prosthesis base 10 is shown in plan view in FIG. 8. The three spacers 81 are arranged on the inner surface of the substantially circular tooth recess 11, 120° apart from one another and projecting inwardly and perpendicularly to the horizontal plane.

The upper part 82 of the spacer 81 is angled for easy insertion of the teeth into the cavity 11 of the prosthesis base 10. The lateral spacing and the basal spacing between the teeth and the cavity of the prosthesis base 10, which provide the adhesive gap through the spacers 81, each correspond to the length 84 and height 86, which amount to 100 μm each.

An articulator 90 with prosthesis is shown schematically in FIG. 9. The finished prosthesis with the upper jaw portion 92 and the lower jaw portion 94 are placed in this articulator which is movable around the vertical axis in order to effect an occlusal correction on the prosthesis teeth.

1. A dental transfer template arrangement with a transfer template and a prosthesis base, both the transfer template and the prosthesis base are produced using a CAD/CAM device, wherein
both the transfer template and the prosthesis base have a number of recesses for teeth, incisal and/or occlusal tooth regions fitting into the transfer template recesses and cervical tooth regions fitting into the prosthesis base recesses,
each tooth is to be adhered into the prosthesis base recesses, characterized in that
the transfer template (20) has an occlusal face (22) facing the occlusal plane, which is implemented as a reference for the presence of disruptive occlusal contacts,
tooth regions (310) which protrude past said face (22) of the transfer template (20) can be polished for an even bite, and
the adhesive area of each tooth (31, 33, 35, 37) in the prosthesis base (10) has a predetermined minimum threshold, said threshold being stored in CAD software of the CAD/CAM device in order to produce the prosthesis base.

2. The transfer template arrangement according to claim 1, characterized in that the CAD/CAM device generates the transfer template (20) based on scanning and CAD data, wherein data sets for the transfer template are each obtained from a three-dimensional scan of a mouth of a patient and from a template library in the CAD software, and the CAD/CAM device creates the prosthesis base (10) based on the three-dimensional scan of the mouth of the patient scanning data and CAD data from a prosthesis base library in the CAD software, and that cervical regions of teeth can be inserted and bonded in the prosthesis base tooth recesses using the transfer template (20).

3. The transfer template arrangement according to claim 2, characterized in that the transfer template (20) is generated in a template form with recesses (21) for teeth (31, 33, 35, 37) matching a dental set of a prosthesis base (10), by rapid prototyping or by milling, and that inner surfaces of the recesses (21) in the transfer template (20) corresponding to the occlusal/incisal outer surfaces of the teeth (31, 33, 35, 37) are generated based on a tooth library, wherein the outer surfaces are saved in the CAD/CAM device corresponding to prefabricated teeth.

4. The transfer template arrangement according to claim 3, characterized in that the threshold value varies for different types of teeth—comprising incisors, canines, premolars and molars—and an enlargement of the adhesive area can be requested to correspondingly adjust the prosthesis base (10) through the CAD software of the CAD/CAM device.

5. The transfer template arrangement according to claim 4, characterized in that the threshold value varies for different teeth (31, 33, 35, 37), comprising prefabricated teeth with different tooth lengths, and an enlargement of the adhesive area can be requested to correspondingly adjust the prosthesis base (10) through the CAD software of the CAD/CAM device.

6. The transfer template arrangement according to claim 5, characterized in that in order to enlarge the adhesive area, the cervical region of the recesses (11) of the prosthesis base (10) can be extended in the incisal/occlusal direction by means of the CAD/CAM device.

7. The transfer template arrangement according to claim 6, characterized in that a calculation of areas of extensions in the transfer template (20) include a manufacturing-related shrinkage factor of the prefabricated teeth, wherein said manufacturing-related shrinkage factor represents the degree of shrinkage of the teeth (31, 33, 35, 37), in approximately ±100 μm.

8. The transfer template arrangement according to claim 7, characterized in that the height of the teeth (31, 33, 35, 37) in the transfer template (20) is determined based on CAD and scanning data and indirectly on patient data, and that regions of a tooth (31, 33, 35, 37), which pass through the prosthesis base (10) and have a height greater than a height extension of the transfer templates (20) and the prosthesis base (10) and in a superimposed state of the transfer templates (20) and the prosthesis base (10), can be abraded to be substantially flush with surrounding surfaces.

9. The transfer template arrangement according to claim 8, characterized in that the transfer template (20) has tooth recesses (21) generated by the CAD/CAM device to define a spatial position of the tooth (31, 33), wherein each tooth (31, 33) is held with a portion of a longitudinal extent by the transfer template (20).

10. The transfer template arrangement according to claim 9, characterized in that the transfer template (20) and the prosthesis base (10) in the assembled state leave a free space (32) surrounding the teeth (31, 33), with a height that corresponds to a portion of the height of the teeth (31, 33).

11. The transfer template arrangement according to claim 10, characterized in that the transfer template (20) and the prosthesis base (10) are supported in the superimposed state via a plurality of supporting points, with respect to each other, and are put into a defined relative position when the teeth (31, 33) are inserted.

12. The transfer template arrangement according to claim 11, characterized in that the transfer template (20) together with the prosthesis base (10) fixedly embed inserted teeth (31, 33) in all three spatial directions, and that disruptive occlusal contacts of the teeth (31, 33) which pass through the transfer template (20) can be abraded or milled off without additional and separate support contacts for the individual teeth (31, 33).

13. The transfer template arrangement according to claim 12, characterized in that the CAD/CAM device, on determining the height of the teeth (31, 33, 35, 37) in the recesses (11) of the prosthesis base takes into account an adhesive gap thereat having a predetermined thickness, so that the outer form is designed to be larger by the adhesive gap than the cervical region of the teeth (31, 33, 35, 37), and that the height of each tooth (31, 33, 35, 37) is precisely determined.

14. The transfer template arrangement according to claim 13, characterized in that on a vestibular side of each tooth (31, 33), window recesses are arranged in the transfer template (20) so that correct height of the teeth (31, 33) in the inner surfaces of the recesses (21) in the transfer template (20) can be checked.

15. The transfer template arrangement according to claim 14, characterized in that the transfer template (20) is provided for either lower jaw or upper jaw prostheses.

16. The transfer template arrangement according to claim 1, characterized in that the predetermined minimum threshold is at least 10 mm².

17. The transfer template arrangement according to claim 1, characterized in that the predetermined minimum threshold is at least 18 mm².

18. The transfer template arrangement according to claim 1, characterized in that the predetermined minimum threshold is at least 25 mm².

19. The transfer template arrangement according to claim 11, characterized in that the plurality of supporting points comprise three.

20. The transfer template arrangement according to claim 13, characterized in that the predetermined thickness comprises partially 0 μm to 500 μm.

21. The transfer template arrangement according to claim 13, characterized in that the predetermined thickness comprises 50 μm to 250 μm.
